(19) United States
(12) Patent Application Publication
(10) Pub. No.: US 2021/0119387 A1
(43) Pub. Date: Apr. 22, 2021

(54) CONNECTOR

(71) Applicant: HIROSE ELECTRIC CO., LTD., Kanagawa (JP)

(72) Inventor: Koichi NAKAMURA, Kanagawa (JP)

(21) Appl. No.: 17/070,314

(22) Filed: Oct. 14, 2020

(30) Foreign Application Priority Data
Oct. 16, 2019 (JP) 2019-189096

(51) Int. Cl. H01R 13/6582; H01R 13/24; H01R 13/512

(52) U.S. Cl. CPC H01R 13/6582; H01R 13/512; H01R 13/2407

(57) ABSTRACT

A shielding shell is provided which is used for a connector to be installed on a casing of a device, and includes a shell cylinder, a spring piece, and a screw portion, in which the spring piece includes a contact point to contact the casing, at an end thereof, the spring piece is configured to maintain the contact between the contact point and the casing due to elasticity of the spring, the screw portion includes a mounting portion to be mounted on the casing, and the mounting portion is configured to contact the casing via a contact surface facing the casing upon the connector being installed on the casing by means of the mounting portion.

### CROSS-REFERENCE TO RELATED APPLICATION

This application claims priority from Japanese Patent Application No. 2019-189096 filed with the Japan Patent Office on Oct. 16, 2019, the entire content of which is hereby incorporated by reference.

### BACKGROUND

### 1. Technical Field

The present disclosure relates to the structure of a connector mounted on a casing of a device such as a power supply, and specifically relates to a connector's shielding structure where a shielding shell included in the connector mounted on a casing of, for example, an on-board inverter or a power supply device and the casing are grounded (earthed) not only at a contact point on a spring piece extending in the longitudinal direction from the shielding shell but also at a screw portion extending in the lateral direction.

### 2. Related Art

A connector for connecting a power cable is conventionally provided to a casing of an electrical component (such as an on-board inverter or a power supply device) provided in an automobile. A shielding process is performed on such a connector to shield the connector from noise generated from a wire in the connector or noise from the outside of the connector, using members such as a shielding conductor and a shielding shell.

In, for example, Japanese Patent No. 6130722, a cable including one or more wires is enveloped by a shielding conductor, and the shielding conductor is placed in such a manner as to be mounted on an outer periphery of a wall portion of a shielding shell fixed to a connection counterpart apparatus with a fastening member, and is crimped with a ring member (shield ring). Accordingly, the shielding conductor is grounded via the connection counterpart apparatus to perform the shielding process on the wires.

### SUMMARY

A shielding shell according to the present disclosure is used for a connector to be installed on a casing of a device, and includes a shell cylinder, a spring piece, and a screw portion, the spring piece includes a contact point to contact the casing, at an end thereof, the spring piece is configured to maintain the contact between the contact point and the casing due to elasticity of the spring, the screw portion includes a mounting portion to be mounted on the casing, and the mounting portion is configured to contact the casing via a contact surface facing the casing upon the connector being installed on the casing by means of the mounting portion.

### BRIEF DESCRIPTION OF DRAWINGS

FIG. 1 is a perspective view of a shielding shell according to one embodiment of the present disclosure;

FIG. 2 is a front view of the shielding shell illustrated in FIG. 1;

FIG. 3 is a rear view of the shielding shell illustrated in FIG. 1;

FIG. 4 is a side view of the shielding shell illustrated in FIG. 1;

FIG. 5 is a perspective view illustrating a state where a connector according to one embodiment of the present disclosure is mounted on a casing of, for example, a power supply device;

FIG. 6 is a front view of the connector illustrated in FIG. 5;

FIG. 7 is a cross-sectional view of the periphery of a screw portion of the connector illustrated in FIG. 5;

FIG. 8 is a cross-sectional view of the periphery of a spring piece of the connector illustrated in FIG. 5; and

FIG. 9 is a diagram of a state where the connector illustrated in FIG. 5 is mounted on a casing of, for example, a power supply device as viewed from the casing side.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A plurality of shielding members (such as a shielding shell, a shielding conductor, and a shield ring in a connector described in, for example, Japanese Patent No. 6130722) is conventionally used for a connector to be mounted on a casing of, for example, an on-board inverter or a power supply device to perform a shielding process on a wire. It takes time and effort to assemble the connector due to a large number of components. Moreover, if a plurality of shielding members is used for the shielding process, the number of contact areas between the plurality of shielding members increases more than necessary as compared to a case of using one shielding member. Accordingly, there arise problems that the possibility of occurrence of a problem such as contact failure increases, the risk of poor grounding increases, and noise cannot be shielded appropriately.

In order to solve such problems as described above, a shielding shell and a connector including the shielding shell are provided in which the connector uses one shielding shell without using a plurality of shielding members, and the shielding shell includes a spring piece extending in a longitudinal direction and a screw portion extending in a lateral direction, and contacts and is grounded with a casing where the connector is installed, not only at a contact point provided at a tip of the spring piece, but also on a contact surface of the screw portion with the casing as a contact point; accordingly, a plurality of contact points necessary for grounding can be provided to one shielding shell, and the shielding process can be performed appropriately.

A shielding shell according to one embodiment of the present disclosure is used for a connector to be installed on a casing of a device, and includes: a shell cylinder; a spring piece; and a screw portion, the spring piece includes a contact point to contact the casing, at an end thereof, the spring piece is configured to maintain the contact between the contact point and the casing due to elasticity of the spring, the screw portion includes a mounting portion to be mounted on the casing, and the mounting portion is configured to contact the casing via a contact surface facing the casing upon the connector being installed on the casing by means of the mounting portion.

As a preferred embodiment of the shielding shell according to the present disclosure, the shielding shell includes a plurality of the spring pieces, and each of the spring pieces extends in a longitudinal direction from an end of the shell cylinder.

As a preferred embodiment of the shielding shell according to the present disclosure, the shielding shell includes a plurality of the screw portions, and each of the screw portions is provided at an end of a supporting piece extending in a lateral direction from the shell cylinder.

As a preferred embodiment of the shielding shell according to the present disclosure, the spring pieces are placed at the end of the shell cylinder in such a manner as to be symmetric about a central axis of the shell cylinder in the longitudinal direction.

As a preferred embodiment of the shielding shell according to the present disclosure, the screw portions are placed on the shell cylinder in such a manner as to be symmetric about a central axis of the shell cylinder in the longitudinal direction.

As a preferred embodiment of the shielding shell according to the present disclosure, the mounting portion has a cylindrical shape, and includes a through-hole for allowing a fastening member to pass therethrough, and the contact surface of the mounting portion has a ring shape.

As a preferred embodiment of the shielding shell according to the present disclosure, the contact surface of the mounting portion includes a projection protruding from the contact surface.

A connector according to one embodiment of the present disclosure is installed on a casing of a device, and includes: a shielding shell; and a housing having the shielding shell therein, the shielding shell includes a shell cylinder, a spring piece, and a screw portion, the spring piece includes a contact point to contact the casing, at an end thereof, the spring piece is configured to maintain the contact between the contact point and the casing due to elasticity of the spring, the screw portion includes a mounting portion to be mounted on the casing, and the mounting portion is configured to contact the casing via a contact surface facing the casing upon the connector being installed on the casing by means of the mounting portion.

As a preferred embodiment of the connector according to the present disclosure, the shielding shell includes a plurality of the spring pieces, and each of the spring pieces extends in a longitudinal direction from an end of the shell cylinder.

As a preferred embodiment of the connector according to the present disclosure, the shielding shell includes a plurality of the screw portions, and each of the screw portions is provided at an end of a supporting piece extending in a lateral direction from the shell cylinder.

As a preferred embodiment of the connector according to the present disclosure, the spring pieces are placed at the end of the shell cylinder in such a manner as to be symmetric about a central axis of the shell cylinder in the longitudinal direction.

As a preferred embodiment of the connector according to the present disclosure, the screw portions are placed on the shell cylinder in such a manner as to be symmetric about a central axis of the shell cylinder in the longitudinal direction.

As a preferred embodiment of the connector according to the present disclosure, the mounting portion has a cylindrical shape, and includes a through-hole for allowing a fastening member to pass therethrough, and the contact surface of the mounting portion has a ring shape.

As a preferred embodiment of the connector according to the present disclosure, the contact surface of the mounting portion includes a projection protruding from the contact surface.

As a preferred embodiment of the connector according to the present disclosure, a mounting surface of the housing, the mounting surface facing a casing outer surface of the casing, is flush with the contact surface of the mounting portion upon the connector being mounted on the casing.

### [Effects of the Invention]

In terms of a shielding shell and a connector including the shielding shell according to the present disclosure, the shielding shell and a casing of, for example, a power supply device are grounded (earthed) not only at a contact point on a spring piece extending in the longitudinal direction from the shielding shell but also at a screw portion extending in the lateral direction. Accordingly, one shielding shell can provide good grounding without using a plurality of shielding members. Consequently, it is possible to save time and effort for the work of assembling shielding shell members, substantially eliminate a potential difference between the casing and the shielding shell, and obtain a sufficient electromagnetic shielding effect as a shielding process for removing the influence of noise.

Embodiments of the present disclosure are described hereinafter with reference to the drawings. In all the drawings for describing the embodiments, the same reference numerals are assigned to the same members in principle, and repeated descriptions thereof are omitted. Moreover, each embodiment is described independently. However, it is not intended to eliminate the configuration of a connector in combination with the constituent elements of the other embodiments.

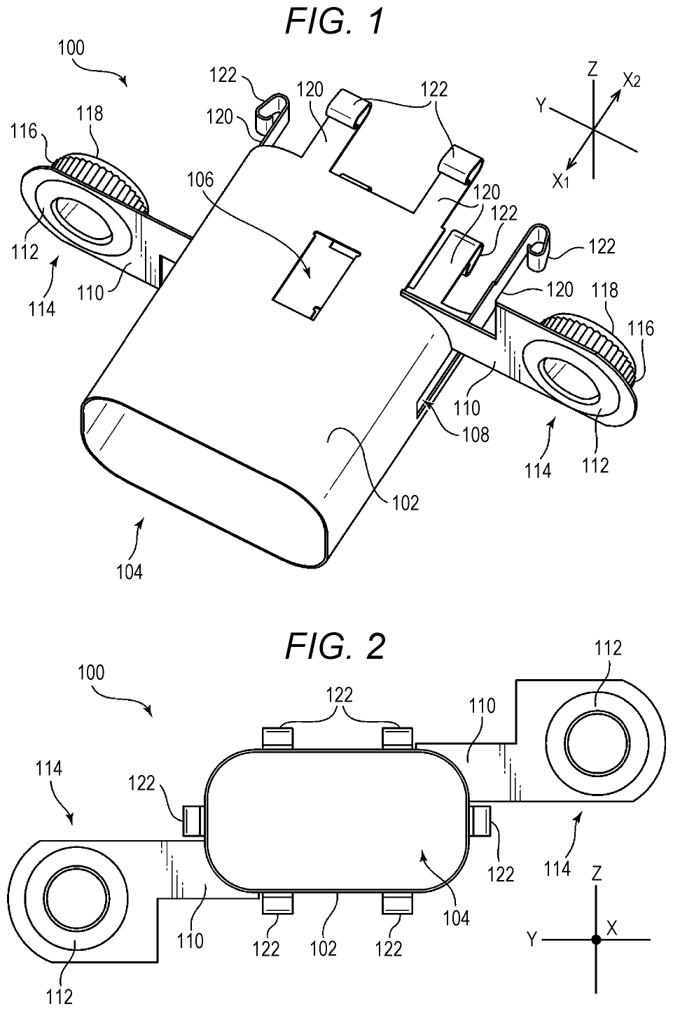

FIG. 1 is a perspective view of a shielding shell according to one embodiment of the present disclosure. FIGS. 2 to 4 are diagrams illustrating the front, back, and side of the shielding shell illustrated in FIG. 1. In these drawings, let a longitudinal direction of a shielding shell 100 (a connector mating direction) be an X-axis direction, let a front end side of the shielding shell 100 be X1, and let a back end side be X2. Moreover, a lateral direction of the shielding shell 100 (a long-side direction of a rectangular opening 104 of a shell cylinder 102 of the shielding shell 100) be a Y-axis direction, and let a height direction of the shielding shell 100 (a short-side direction of the rectangular opening 104 of the shell cylinder 102 of the shielding shell 100) be a Z-axis direction. The above matters shall apply to the other drawings.

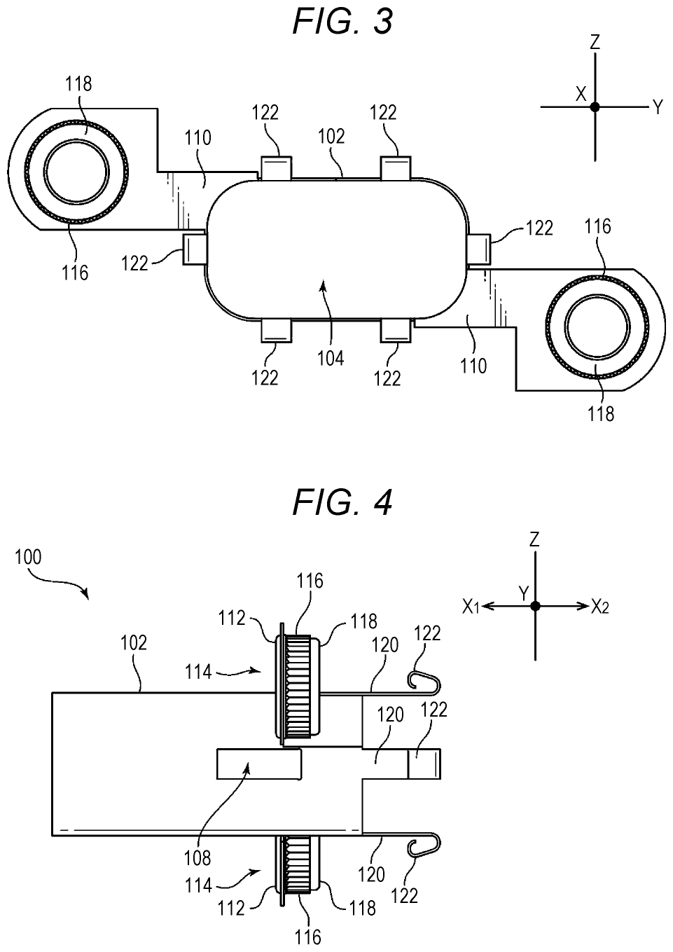

The shielding shell 100 illustrated in FIGS. 1 to 4 is formed of a conductive member, and includes the shell cylinder 102, a spring piece 120, and a screw portion 114. The shell cylinder 102 includes therein the opening 104 leading from the front end side (X1 side) through to the back end side (X2 side). The shell cylinder 102 includes a side wall opening 106 in a side wall in the height direction (Z-axis direction), and a slit 108 in a side wall in the lateral direction (Y-axis direction). When the side wall opening 106 and the slit 108 can be used to receive, for example, a fixing jig or resin upon integral molding (also referred to as insert molding) with a housing configuring a connector. The opening 104 in the shell cylinder 102 has a rectangular shape on a Y-Z plane as illustrated in, for example, FIGS. 2 and 3, but is not limited to this shape, and is simply required to have a shape forming a cylindrical opening such as a square, circle, or ellipse.

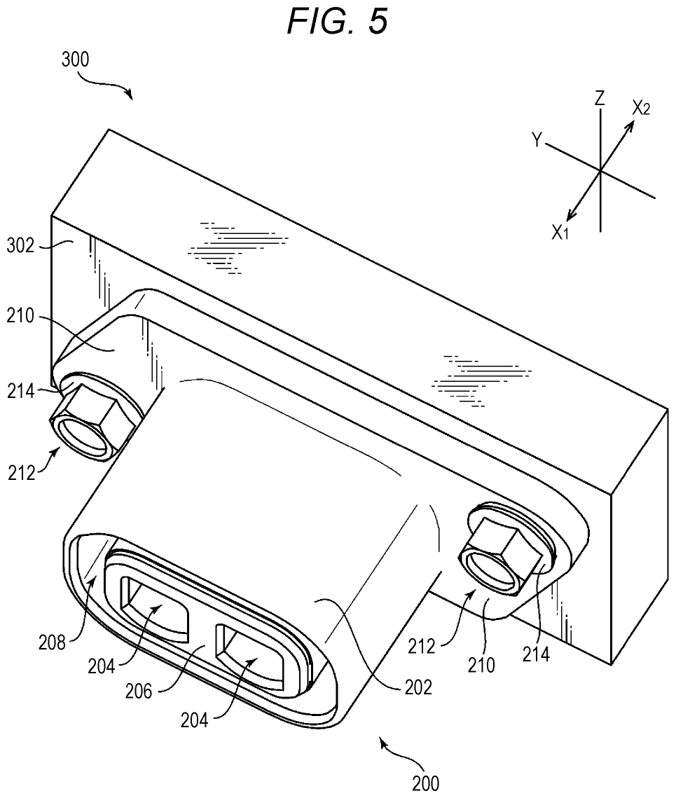

The screw portion 114 includes a mounting portion 116 for mounting on a casing 300 (refer to FIG. 5) of, for example, a power supply device. As illustrated in, for example, FIGS. 3 and 4, the mounting portion 116 includes a contact surface 118 configured in such a manner as to contact the casing 300, on the side facing the casing 300 (the X2 side). The contact surface 118 of the mounting portion 116 is configured in such a manner as to contact the casing 300 when a connector 200 (refer to FIG. 5) including the shielding shell 100 is installed on the casing 300 by means of the mounting portion 116. The contact surface 118 and the casing 300 are brought into contact with each other and therefore can be grounded.

It is possible to provide a plurality of the screw portions 114. The screw portion 114 can be provided to each of both side walls of the shell cylinder 102 in the lateral direction (Y-axis direction) in the shielding shell 100. Each of the screw portions 114 is provided at an end of a supporting piece 110 extending in the lateral direction (Y-axis direction) from the shell cylinder 102.

The plurality of the screw portions 114 can be symmetrically placed with respect to the central axis of the shell cylinder 102 in the longitudinal direction (X-axis direction). In other words, two screw portions 114 of the shielding shell 100 are provided at positions that are symmetric about the central axis in the longitudinal direction (X-axis direction). Naturally, it is not intended to limit the number of the screw portions 114 to two. The number can be increased or decreased depending on the purpose, for example, fixing or grounding the connector.

The screw portion 114 includes a through-hole being a screw hole for allowing a fastening member such as a bolt or screw to pass therethrough. The screw portion 114 can include a screw supporter 112 protruding from the surface of the supporting piece 110, on a front end side (X1 side) thereof in the longitudinal direction (X-axis direction) of the shielding shell, in such a manner as to surround the entrance of the through-hole. The screw supporter 112 can prevent, for example, a bolt or screw being a fastening member from loosening due to contact with the head (for example, the bolt head or screw head) of, for example, the tightened bolt or screw when, for example, the bolt or screw is tightened to mount the connector 200 including the shielding shell 100 on the casing 300 (refer to FIG. 5).

The screw portion 114 includes a through-hole being a screw hole for allowing a fastening member such as a bolt or screw to pass therethrough. Specifically, as illustrated in FIGS. 1 to 4, the mounting portion 116 has a cylindrical shape, and includes a through-hole for allowing a fastening member such as a bolt or screw to pass therethrough. The contact surface 118 of the mounting portion 116, the contact surface 118 contacting the casing 300 (refer to FIG. 5), has a ring shape. In the embodiment illustrated in FIGS. 1 to 4, the contact surface 118 of the mounting portion 116 is, but not limited to, a flat surface. The contact surface 118 can be provided with one or more projections (not illustrated) protruding from the contact surface 118. The projection can function as a contact point with the casing 300.

As illustrated in, for example, FIGS. 1 to 4, the spring piece 120 includes a contact point 122 for contacting the casing 300 (refer to FIG. 5), at an end thereof. The spring piece 120 can maintain the contact between the contact point 122 and the casing 300 due to the elasticity of the spring when the connector 200 (refer to FIG. 5) including the shielding shell 100 is mounted on the casing 300. It is possible to provide a plurality of the spring pieces 120. Each of six spring pieces 120 extends in the longitudinal direction (X-axis direction) from an end of the shell cylinder 102 on the shielding shell 100.

Moreover, the spring pieces 120 can be placed at the end of the shell cylinder 102 in such a manner as to be symmetric about the central axis of the shell cylinder 102 in the longitudinal direction (X-axis direction). In other words, one of the six spring pieces 120 of the shielding shell 100 is provided at a position that is symmetric about the central axis in the longitudinal direction (X-axis direction) with respect to another spring piece 120. Naturally, it is not intended to limit the number of the spring pieces 120 to six. The number can be increased or decreased depending on the purpose, for example, fixing or grounding the connector.

As illustrated in FIGS. 1 to 4, not only is the casing 300 (refer to FIG. 5) of, for example, a power supply device grounded (earthed) at the contact points 122 of the spring pieces 120 extending in the longitudinal direction (X-axis direction) from the shielding shell 100, but also the shielding shell 100 and the casing 300 are grounded at the screw portions 114 extending in the lateral direction (Y-axis direction). Accordingly, one shielding shell can provide good grounding without using a plurality of shielding members. Consequently, it is possible to save time and effort for the work of assembling the shielding shell members, substantially eliminate a potential difference between the casing 300 and the shielding shell 100, and obtain a sufficient electromagnetic shielding effect as a shielding process for removing the influence of noise.

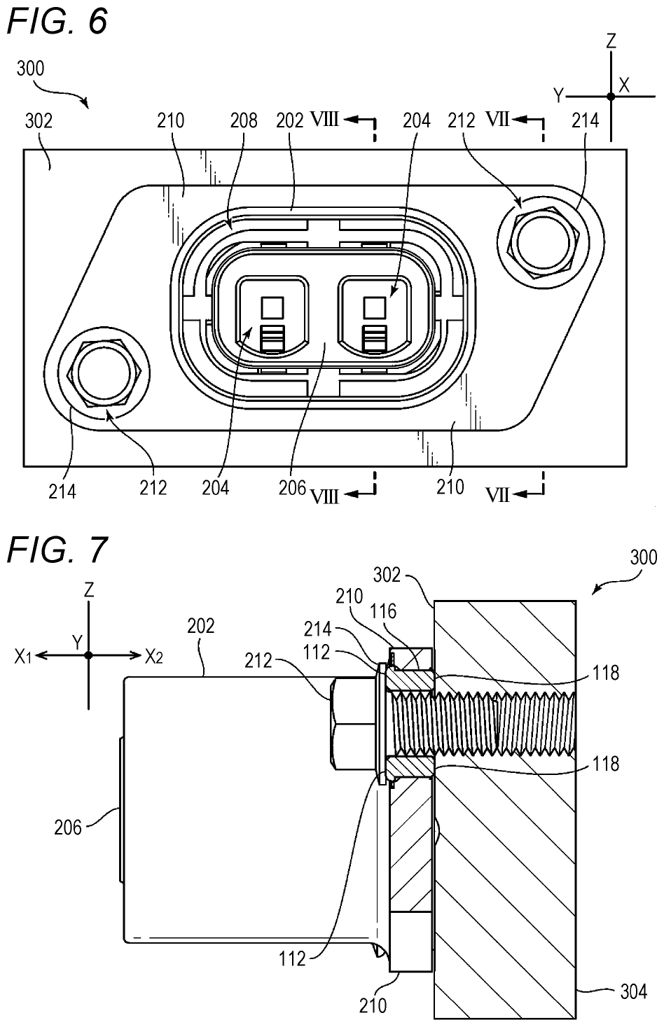

FIG. 5 is a perspective view illustrating a state where a connector according to one embodiment of the present invention is mounted on a casing of, for example, a power supply device. FIG. 6 is a front view of the connector illustrated in FIG. 5. The shielding shell 100 (refer to, for example, FIG. 1) is covered with a housing 202 of the connector 200, and included in the connector 200. The connector 200 is formed of an insulating resin such as liquid crystal polymer (LCP) by integral molding (insert molding) with the shielding shell 100.

The connector 200 includes the shielding shell 100 (refer to, for example, FIG. 1) and the housing 202 inside which the shielding shell 100 is included. The configuration of the shielding shell 100 inside the housing 202 is, for example, the configuration as illustrated in FIGS. 1 to 4. The connector 200 includes a housing protrusion 206 having a cable port 204, inside the cylindrical housing 202. The cable port 204 is an insertion port for mounting a cable such as a coaxial cable (not illustrated) to the connector 200.

A groove 208 being a gap in between with the cylindrical housing 202 is formed around the housing protrusion 206. The periphery of a connection portion of the cable, which is inserted into the cable port 204, and connected to the device on the casing 300 side, is surrounded by the groove 208 and the shell cylinder 102 of the shielding shell 100 inside the housing 202; accordingly, the connector 200 can obtain the electromagnetic shielding effect.

A housing flange 210 expanding on a plane (Y-Z plane) vertical to the major-axis direction (X-axis direction) is provided to the housing 202 of the connector 200 to mount the connector 200 on the casing 300. The housing flange 210 includes a screw hole for allowing a screw (or bolt) 212 to pass therethrough. The screw (bolt) 212 fastens the connector 200 onto a casing outer surface 302 of the casing 300. In FIGS. 5 and 6, the entire image of the device is omitted, and only a part of the casing 300 is illustrated. The casing 300 is a casing of, for example, an electrical component (such as an on-board inverter or a power supply device) provided in an automobile.

When the connector 200 is mounted on the casing 300 with the screw 212, a screw head 214 of the tightened screw 212 comes into contact with the screw supporter 112 exposed from the surface of the housing flange 210 as illustrated in FIG. 7, and accordingly the loosening of the screw 212 can be prevented. FIG. 7 is a cross-sectional view of the periphery of a screw portion of the connector illustrated in FIG. 5. In the mounting portion 116 of the screw portion 114 provided to the shielding shell 100, the screw head 214 of the screw 212 is screwed down against the screw supporter 112 on the front end side (X1 side) in the shielding shell 100. Accordingly, the mounting portion 116 is pushed toward the back end side (X2 side) to cause the contact surface 118 of the mounting portion 116 to firmly contact the casing outer surface 302 of the casing 300, which enables grounding. A casing inner surface 304 side of the casing 300 includes a terminal (not illustrated) of a device that is connected to a cable (not illustrated) included in the connector 200.

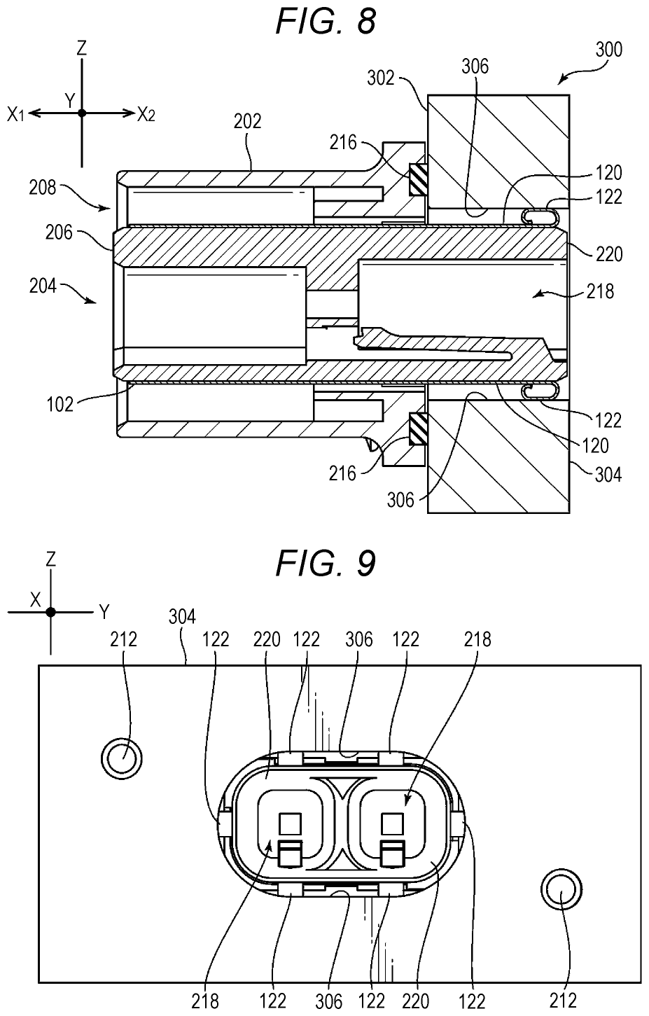

FIG. 8 is a cross-sectional view of the periphery of a spring piece of the connector illustrated in FIG. 5. FIG. 9 is a diagram of a state where the connector illustrated in FIG. 5 is mounted on a casing of, for example, a power supply device as viewed from the casing side. When the connector 200 is mounted on the casing 300 of, for example, a device, the spring pieces 120 are inserted into a hole provided in the casing 300 together with a coupler 220 located on a side (the X2 side) opposite to the housing protrusion 206, the coupler 220 including a terminal port 218 therein. Each of the contact points 122 of the spring pieces 120 is pushed by the elastic force of at least one of the spring piece 120 and the contact point 122 against an inner wall ground surface 306 of the casing 300, and contacts the inner wall ground surface 306. The spring piece is supported by the coupler 220. The contact point 122 is pushed by an elastic force thereof against the casing 300 (specifically, the inner wall ground surface 306). Accordingly, even if an impact, vibration, or the like is added to the connector 200 or the casing 300, the contact point 122 and the inner wall ground surface 306 are not separated, and the contact therebetween is maintained.

As illustrated in FIG. 8, the terminal port 218 provided inside the coupler 220 can accommodate a part of a connection terminal (not illustrated) of the tip portion of the cable. Moreover, the connector 200 can include a ring-shaped rubber gasket 216 in such a manner as to surround the periphery of the coupler 220. It is possible to prevent a liquid such as water from entering through a gap between the connector 200 and the casing 300 when the connector 200 is mounted on the casing 300.

As also illustrated in FIGS. 5 to 9, the casing 300 is grounded not only at the contact points 122 of the spring pieces 120 extending in the longitudinal direction (X-axis direction) from the shielding shell 100, but the shielding shell 100 and the casing 300 are grounded at the screw portions 114 extending in the lateral direction (Y-axis direction). Accordingly, one shielding shell can provide good grounding without using a plurality of shielding members. Individual embodiments of the present disclosure are not independent, and can be carried out as appropriate in combination of the embodiments.

### INDUSTRIAL APPLICABILITY

A shielding shell according to the present disclosure can be used for, for example, a connector that is mounted on a casing of an electrical component (such as an on-board inverter or a power supply device) provided in an automobile. A connector according to the present disclosure can be used for a purpose, for example, connecting a cable such as a coaxial cable to an electrical component (such as an on-board inverter or a power supply device) provided in an automobile.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A shielding shell used for a connector to be installed on a casing of a device, comprising:
a shell cylinder;
a spring piece; and
a screw portion, wherein
the spring piece includes a contact point to contact the casing, at an end thereof,
the spring piece is configured to maintain the contact between the contact point and the casing due to elasticity of the spring,
the screw portion includes a mounting portion to be mounted on the casing, and
the mounting portion is configured to contact the casing via a contact surface facing the casing upon the connector being installed on the casing by means of the mounting portion.

2. The shielding shell according to claim 1, wherein
the shielding shell includes a plurality of the spring pieces, and
each of the spring pieces extends in a longitudinal direction from an end of the shell cylinder.

3. The shielding shell according to claim 1, wherein
the shielding shell includes a plurality of the screw portions, and
each of the screw portions is provided at an end of a supporting piece extending in a lateral direction from the shell cylinder.

4. The shielding shell according to claim 2, wherein the spring pieces are placed at the end of the shell cylinder in such a manner as to be symmetric about a central axis of the shell cylinder in the longitudinal direction.

5. The shielding shell according to claim 2, wherein the screw portions are placed on the shell cylinder in such a manner as to be symmetric about a central axis of the shell cylinder in the longitudinal direction.

6. The shielding shell according to claim 1, wherein
the mounting portion has a cylindrical shape, and includes a through-hole for allowing a fastening member to pass therethrough, and
the contact surface of the mounting portion has a ring shape.

7. The shielding shell according to claim 6, wherein the contact surface of the mounting portion includes a projection protruding from the contact surface.

8. A connector to be installed on a casing of a device, comprising:
a shielding shell; and
a housing including the shielding shell therein, wherein
the shielding shell includes a shell cylinder, a spring piece, and a screw portion,
the spring piece includes a contact point to contact the casing, at an end thereof,
the spring piece is configured to maintain the contact between the contact point and the casing due to elasticity of the spring,
the screw portion includes a mounting portion to be mounted on the casing, and
the mounting portion is configured to contact the casing via a contact surface facing the casing upon the connector being installed on the casing by means of the mounting portion.

9. The connector according to claim 8, wherein
the shielding shell includes a plurality of the spring pieces, and
each of the spring pieces extends in a longitudinal direction from an end of the shell cylinder.

10. The connector according to claim 8, wherein
the shielding shell includes a plurality of the screw portions, and
each of the screw portions is provided at an end of a supporting piece extending in a lateral direction from the shell cylinder.

11. The connector according to claim 9, wherein the spring pieces are placed at the end of the shell cylinder in such a manner as to be symmetric about a central axis of the shell cylinder in the longitudinal direction.

12. The connector according to claim 9, wherein the screw portions are placed on the shell cylinder in such a manner as to be symmetric about a central axis of the shell cylinder in the longitudinal direction.

13. The connector according to claim 8, wherein
the mounting portion has a cylindrical shape, and includes a through-hole for allowing a fastening member to pass therethrough, and
the contact surface of the mounting portion has a ring shape.

14. The connector according to claim 13, wherein the contact surface of the mounting portion includes a projection protruding from the contact surface.

15. The connector according to claim 8, wherein a mounting surface of the housing, the mounting surface facing a casing outer surface of the casing, is flush with the contact surface of the mounting portion upon the connector being mounted on the casing.
